(19) United States
(12) Patent Application Publication
(10) Pub. No.: US 2002/0135534 A1
(43) Pub. Date: Sep. 26, 2002

(54) Single telephonic line input operable stationary variable information exhibitor and audio pager

(76) Inventor: Thomas J. Elsten JR., Hendersonville, TN (US)

Correspondence Address: Peter Gibson, 6316 Greenspring Avenue, #307, Baltimore, MD, 21209, US

(21) Appl. No.: 09/767,899

(22) Filed: Jan. 24, 2001

(51) Int. Cl. G09G 5/00

(52) U.S. Cl. 345/1.1

(57) ABSTRACT

A sign displays information upon a screen in a variable manner including ‘moving messages’ which information, in an appropriate format to operate the display, is provided in digital form from a digital processor or computer. An operator possessing appropriate software installed in a remote digital device may alter the information displayed by input transmitted over wire or radio frequency to a single telephonic line operably connected to a modem through a data fax switch. Alternatively, a voice message received through the same telephonic line is routed by the data fax switch to an amplifier operably connected to at least one loudspeaker which may be incorporated into the construction of the sign along with the data fax switch and the screen. A programmable microprocessor directly controlling the screen may be included in the confines of the sign and receive digital signals directly from the data fax switch. The screen is remotely alterable as regards content of the information displayed with appropriate digital signal input through the same telephonic line as utilized for reception of audio or analog input for announcement through the amplifier and loudspeaker(s). This system primarily enables display of transportation arrival and other information as well as audio paging from a single moving message sign located in a waiting room with supply of a single telephonic line and standard electrical power supply. Remote alteration of the information by transportation personnel remotely, while en route, is enabled together with audio paging by both transportation personnel and the public, if desired, through utilization of a single telephonic line.

### BACKGROUND OF THE INVENTION

1. Field of the Invention

The field of the present invention is related most pertinently to variable reading stationary sign exhibitors, especially with sound and electric circuit control, and is also related, less inclusively, with paging systems and selective visual display means in electrical communications.

2. Discussion of the Prior Art

GB 2 113 445 issued to Rudd Dec. 23, 1981 for a ‘Customer operated automatic message dispenser system’ discloses an ‘automatic message dispenser system’ triggered by proximity to an induction coil which can be either audio or visual and overridden by a microphone.

FR 2 535 881 issued to Bal May 11, 1984 for a ‘Public information kiosk with video and sound’ discloses a ‘public information kiosk with video and sound’ which is connected to a central computer, has a TV display, and allows customer use of a keyboard in queries.

FR 2 642 553 issued to Baloutch Aug. 3, 1990 for a ‘Passenger information system for bus stops and similar locations’ discloses an ‘information system for bus stops’ such as expected time of arrival, which is displayed on panels or announced through a loudspeaker, and which is activated by infrared emission by the bus and reception by the bus stop.

U.S. Pat. No. 4,967,194 issued to Haruki Oct. 30, 1990 for a ‘Radio Message Display System’ discloses a ‘radio message display system’ with visual display of a message transmitted by the radio link between a paging transmitter and receiver.

U.S. Pat. No. 5,061,921 issued to Lesko et al. Oct. 29, 1991 for a ‘Remote-Controlled Message Sign’ discloses a ‘remote controlled message sign’ controlled by a pager which receives radio signals from a paging service and outputs signals which control drive motors in a multiple position message device.

EP 468-726-A issued to Matai Jan. 29, 1992 for a ‘Paging receiver having alternately driven audible and visual warnings’ discloses a ‘paging receiver’ with ‘alternately driven audible and visual warnings’ derived from a digitized radio frequency signal received thereby and triggered when the paging number received matches the paging number assigned.

WO 93/02433 by Anagnostopoulos published Feb. 4, 1993 entitled ‘Method Of Personally Addressed Communication, Information, Guidance And Quick Processing Of The Procedures In The Airports discloses a method of assisting airport users “characterised by the supply of a small portable wireless device to” each which is supplied with information from the airport.

U.S. Pat. No. 5,444,767 issued to Goetcheus et al. Aug. 22, 1995 for ‘Systems And Methods For Recording And Delivering Personalized Audio Messages discloses provision for a customer in a store to pick up a telephone and leave an audio message which is digitized and transmitted to a store front playback device where the signal is converted to analog and broadcast by a loudspeaker.

U.S. Pat. No. 5,778,577 issued to Bailey Jun. 14, 1998 for ‘Changeable Numeric Signs’ discloses a ‘changeable numeric sign’ using horizontal flaps rotated by a motor controlled on site or remotely by telephone, pager, or radio remote controller.

Statement of Need

The prior art reviewed above offers visual and audio displays for messages or information transmitted by a variety of means but none permitting either audio announcement or visual display according to the type of input through a telephone line, i.e. either an alphanumeric message containing information from keyboard input or audio paging from audio telephonic input. A need for the same is hence observed.

### SUMMARY OF THE INVENTION

Objects of the Invention

The encompassing object of the present invention is to provide a stationary variable message exhibitor and pager which enables both audio announcements and the remote alteration of the messages displayed through the use of a single telephone line.

A first auxiliary object of the present invention is to provide a stationary variable message exhibitor/pager which enables both audio announcements and the remote alteration of the messages displayed by remote transportation personnel in transit through the use of a single telephone line.

A first ancillary object of the present invention is to provide a stationary variable message exhibitor/pager which enables both audio announcements and the full remote control of the messages displayed by remote transportation personnel in transit through the use of a single telephone line.

A second auxiliary object of the present invention is to provide a stationary variable message exhibitor/pager which enables audio announcements by transportation personnel in transit and the remote alteration of the messages displayed through the use of a single telephone line.

A third auxiliary object of the present invention is to provide a stationary variable message exhibitor/pager which enables audio announcements by both transportation personnel in transit and the public and remote alteration of the messages displayed all through the use of a single telephone line.

A second ancillary object of the present invention is to provide a stationary variable message exhibitor/pager which enables audio announcements by the public with selective override by transportation personnel audio announcements and the remote alteration of the messages displayed through the use of a single telephone line.

A fourth auxiliary object of the present invention is to provide a stationary variable message exhibitor/pager requiring only one standard electrical outlet which enables both audio announcements and remote alteration of the messages displayed through the use of a single telephone line.

Principles Relating to the Present Invention

In achievement of the objectives set forth above a combined variable message exhibitor and audio pager is considered which: automatically distinguishes data signals from voice signals; routes the data signals to a programmable microprocessor controlling the message displayed upon a screen; and routes the voice signals to an amplifier for broadcast over a loudspeaker. The microprocessor is programmable with appropriate software operable upon a personal computer (PC) operably connected to said microprocessor.

With automatic routing of a data signal produced by the correct software to the microprocessor the same is readily controlled remotely. If desired, the fields available for control may be restricted, thereby resulting in the limited ability to alter the variable message displayed by the sign. If a portion of said variable message is dedicated to the representation of time, for example, in what is conventionally termed a ‘clock’ there is no apparent reason to enable alteration of this feature except to reflect the biannual advance or retard by one hour occasioned by the use of Daylight Savings Time.

Audio announcements are made by the loudspeaker(s) located in vicinity of the sign, i.e. within hearing distance of the sign and preferably attached to or incorporated into the same. Audio signals received from the same telephonic line utilized for alteration of the variable message displayed by the sign may be directly routed to the amplifier and hence broadcast over the loudspeaker(s) in which case anyone connecting by voice through that telephonic line is permitted to make an audio announcement. Remote connection with this single telephonic with either voice or data signal is readily enabled by radio frequency telephonic transmission by an appropriate remote device.

In the case of a voice signal a ‘mobile’ or ‘cellular’ telephone is an appropriate remote device. In the case of a data signal a PC possessing a modem connected to a ‘mobile’ or ‘cellular’ type radio frequency telephonic transmitter is an appropriate remote device as is a ‘wireless’ mini-computer or what is currently known conventionally as a ‘personal digital assistant’ (DA). What is commonly known as a ‘laptop’ computer, which is dimensionally medial to a PC and a PDA, if connected to or in possession of radio frequency telephonic transmission, is also considered an appropriate remote device for remote data signal transmission.

The primary intended practical utilization of an embodiment in fulfillment of the principles relating to the present invention is in the conveyance of information relating to and associated with the scheduling of public transportation, particularly trains, but inclusive of buses, airplanes, ferries, et cetera. If desired the information conveyed, both audio and visual, may be restricted in control or access to transportation personnel. It is normally considered desirable to so restrict the alteration and control of the variable message displayed on the screen of the sign and this is readily accomplished with appropriate programming of the microprocessor controlling the display whereby appropriate software and if desired, use of a password or other code, is necessary to effect alteration or control by reception of a data signal through a telephonic line.

If restriction of the ability to make audio announcements is desired it is considered that an easily practical method would simply be utilization of an unpublished number for the single telephonic line utilized with dissemination of the number only to authorized transportation personnel. This, however, would effectively deny the ability of the public to make an audio announcement. An alternative restriction would provide override capability for voice signals transmitted by transportation personnel. While there are a variety of means available to effect this restriction it is considered that the simplest is perhaps to provide a second telephonic line with an unpublished number switched to supersede when connected, any other voice signal being routed by the data fax switch to the amplifier.

Alternatively, a radio frequency receiver operating an input switch for a single telephonic line would enable transportation personnel to remotely terminate reception of a voice signal and free the single telephonic line for their voice signal. A third option, considered likely the best, is a hybrid of the first two. Rather than add a second line a second number to the same line which is unpublished and which is recognized as superseding the public number in priority of audio announcement may be added. A switch similar to the radio frequency controlled input switch but with the ability to sense the unpublished number being called rather than reception of a radio frequency signal would be less expensive than either a second line or the necessity of radio transmission for this purpose. In a primary intention of the utilization of an embodiment in fulfillment of the principles relating to the present invention, however, no restriction on reception of analog, i.e. voice, signals with automatic routing to the amplifier is considered desirable.

In addition to utilization with only one telephonic line it is also considered desirable in a preferred embodiment in accordance with the principles relating to the present invention to require use of only one standard alternating current (AC) electrical outlet. A transformer for the microprocessor in control of the screen in display of the variable message is, in this case, considered advantageous, preferably with a battery back-up. The display screen is preferably illuminated and may operate on standard AC voltage or direct current (DC), which, if of appropriate voltage, may be supplied from the same transformer utilized to supply the microprocessor. If the illuminated display screen operates on a different voltage another transformer may be utilized still employing a single AC power supply to the sign.

In any case an illuminated display screen possesses an array of illuminative display elements. Light Emitting Diodes (LED) are preferred for low power consumption and the ability to be directly controlled by and supplied with the same voltage DC as the programmable controller. An array of incandescent lights is considered a satisfactory alternative which will utilize AC. The use of liquid crystal diodes (LCD) in an array to form the display screen may be less than wholly satisfactory owing to limitations in visibility, however, this type of display screen is easily operated upon the power derived from the transformer supplying DC to the microprocessor and is the least power consumptive of currently known technology in relying upon external illumination.

Illuminated or not, the display screen technology utilized must be digitally controlled and preferably presents what is colloquially called a ‘moving message’ whereby the ‘firing’ of the display elements is done by serial progression across the sign by columns, for horizontal motion, or rows, for vertical motion, of the message presented. In this case one column or row is the first to receive a pattern which is replicated by each succeeding column or row serially at the instant the first column or row receives or presents a new pattern. Groups of columns or rows are, of course, organized to form larger patterns typically comprised of alphanumeric characters. The display screen must, of course, possess a large enough array to permit intelligible messages which, in the case of a moving message, is essentially determined by the length of the longest single word anticipated in any message intended. Messages are preferably repetitive with appropriate updates made automatically in the case of the time and by preferably remote data signal transmission otherwise.

Further appreciation of the detailed requirements, operation, and benefits associated with a preferred embodiment of the principles relating to the present invention may be gained in the below discussion, particularly if made with reference to the drawings attached hereto and briefly described immediately below.

### BRIEF DESCRIPTION OF THE DRAWINGS

FIG. 1 is a composite view of the operation of a system in accordance with the principles relating to the present invention illustrating the visual display of a moving message and audio announcement in the waiting room of train station with both voice and data signals being receivable through a single telephonic line.

FIG. 2 is a plain elevational view of a sign displaying a moving message on a screen comprised of an array of display elements suitable for use with an embodiment in accordance with the principles relating to the present invention.

FIG. 3 is a perspective view of a remote data signal input device suitable for use with an embodiment with the principles relating to the present invention.

FIG. 4 is a schematic view of a first arrangement of components comprising a preferred embodiment in accordance with the principles relating to the present invention.

FIG. 5 is a schematic view of a second arrangement of components comprising a preferred embodiment in accordance with the principles relating to the present invention.

FIG. 6 is a schematic view of a third arrangement of components comprising a preferred embodiment in accordance with the principles relating to the present invention.

FIG. 7 is a schematic view of a fourth arrangement of components comprising a preferred embodiment in accordance with the principles relating to the present invention.

FIG. 8 is a schematic view of a fifth arrangement of components comprising a preferred embodiment in accordance with the principles relating to the present invention.

NOMENCLATURE

| | | | |
|---|---|---|---|
| 10 | sign | 40 | member of the public |
| 11 | waiting room | 47 | telephone |
| 12 | variable message | | |
| 13 | audio announcement | | |
| 15 | loudspeaker | | |
| 16 | electrical power supply line | | |
| 17 | telephonic line | | |
| 19 | digital processor | | |
| 20 | radio frequency signal | | |
| 21 | array of display elements | | |
| 22 | display screen | | |
| 23 | programmable controller | | |
| 25 | amplifier | | |
| 26 | transformer | | |
| 27 | router (fax data switch) | | |
| 29 | train | | |
| 30 | remote transportation personnel | | |
| 31 | radio frequency receiver | | |
| 32 | computer | | |
| 33 | modem | | |
| 35 | speaker wires | | |
| 36 | standard AC outlet | | |
| 37 | standard telephone jack | | |
| 39 | radio frequency transmitter | | |

### DETAILED DESCRIPTION OF THE PREFERRED EMBODIMENT

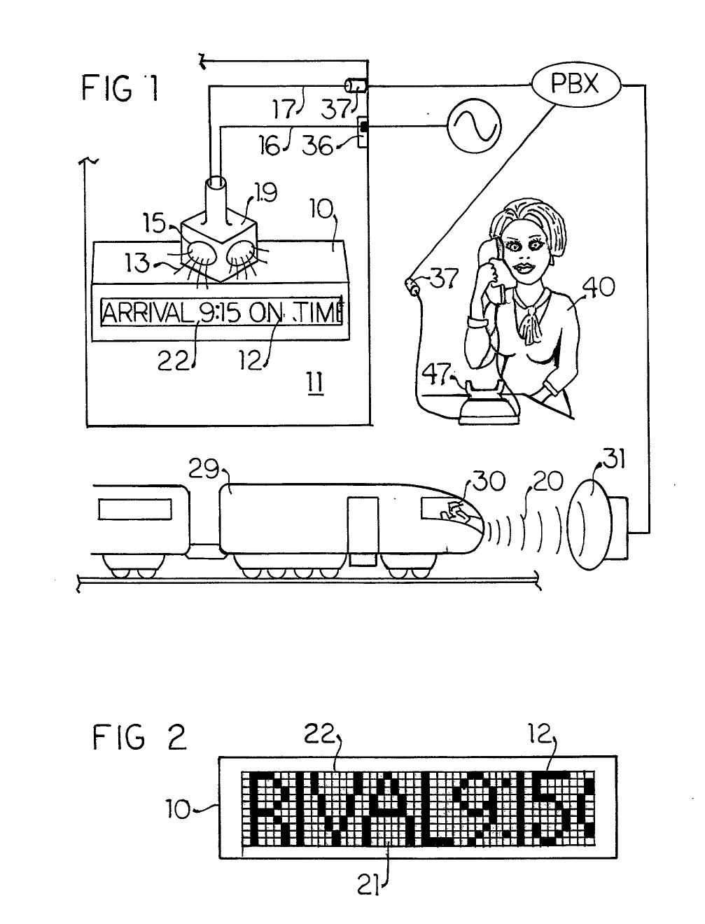

FIG. 1 illustrates a system in accordance with the principles of the present invention wherein a stationary exhibitor, known hereinafter as a sign 10 and primarily intended to be located in a waiting room 11 of a public transportation station, is seen presenting a variable message 12: ARRIVAL 9:15 ON TI wherein it is understood that a scheduled arrival for 9:15 is on time and that the variable message 12 is further of a moving message type with continuous scrolling of information from left to right in the conventional manner. Said system is further seen to be projecting an audio announcement 13 from at least one loudspeaker 15 which may be identical to or different from the information presented by the variable message 12 upon the visual display screen 22.

In the wholly exemplary case depicted in FIG. 1 two of four loudspeakers 15 are clearly seen upon two adjacent faces of a rectangular attachment projecting upward from the middle of the sign 10 which may possess another display screen 22 opposed to that seen herein. Only one loudspeaker 15 is sufficient and it is not necessary that the loudspeaker be attached to the sign 10 as depicted therein but only that the variable message 12 be visible, and the audio announcements 13 audible, to people located in the waiting room 11 or other area concerned. And, as seen in FIGS. 1 & 4-8, it is necessary for a system in accordance with the principles relating to the present invention to enable operation with only one telephonic line 17 and only one standard telephone jack 37 while, as seen in FIGS. 1 & 4-6, it is preferred to enable operation with only one electric power line 16, which, as clearly seen in FIG. 1, requires only one standard alternating current (AC) electrical power outlet, herein known as a standard AC outlet 36.

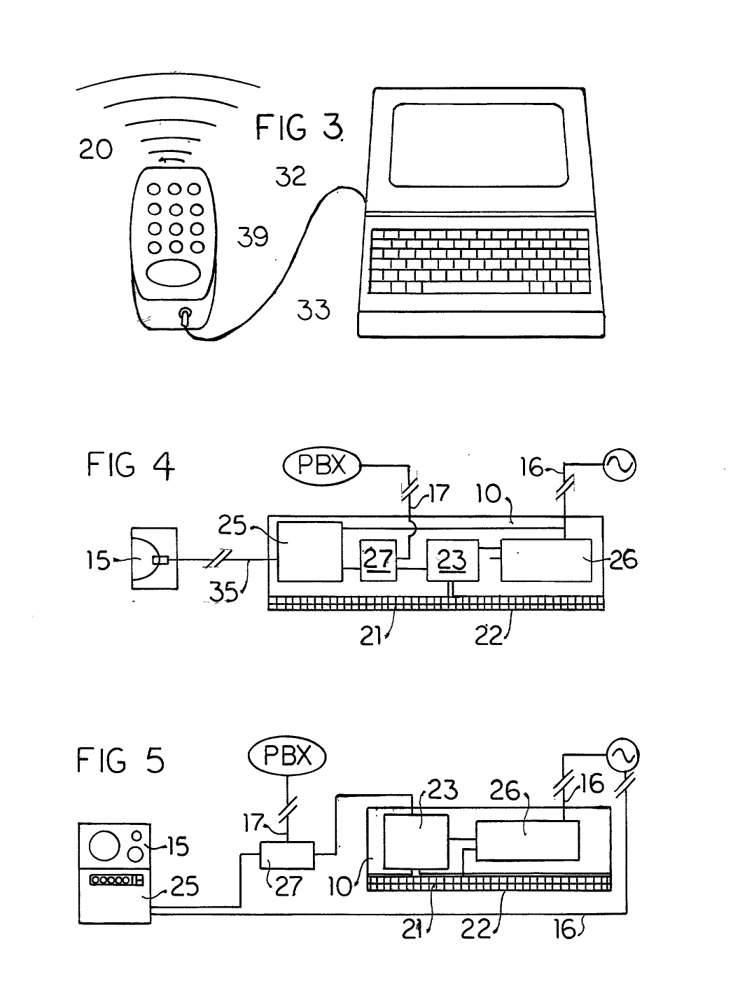

This single telephonic line 17 receives, through the standard telephone jack 37 wired to a public broadband exchange (PBX), both data and voice signals. The signals are received through the single telephonic line 17 by a router 27 as seen in FIGS. 4-8, comprised of a data-fax switch(er) in a preferred embodiment in accordance with the present invention, which recognizes a digital data, i.e. facsimile, signal as being different from a voice signal and which routes data signals to a digital processor 19 and routes voice signals to an amplifier 25 which provides an appropriately amplified analog voice signal to the loudspeaker(s) 15.

The result, therefore, of a voice signal being received by a system in accordance with the principles relating to the present invention is to broadcast an audio announcement 13 which is primarily intended to be made in a waiting room 11 of a public transportation station or terminal. If a telephone number assigned to said single standard telephone jack 37 is published or otherwise made public, with preference being made for dissemination among users of that public transportation station or terminal, then a member of the public 40 may simply use an ordinary telephone 47 to dial that number and make an audio announcement 13 and, hopefully, inform someone expected to be in the waiting room 11 of any information desired verbally.

Remote, en route or otherwise, transportation personnel may also use this single telephonic line 17 for making audio announcements 13 which may be associated with the variable message 12 presented on the display screen 22. The use of a radio frequency signal 20 for transmission of a voice signal received by a radio frequency receiver 31 or transponder connected to a public telephone line connected to the PBX enables transportation personnel 30 aboard an en route train 29, for example, to make an audio announcement 13 concerning the anticipated arrival time of the train or relate verbally any other information desired. A member of the public 40 may also do this with what is commonly known as a mobile or cellular telephone 41 which utilizes radio frequency signals 20.

More pertinently to the variable message 12 displayed by the display screen(s) 22 possessed of the sign 10, however, data signals may also be transmitted by radio frequency signal 20 and this enables remote transportation personnel 30, en route if desired, to alter said variable message 12. Generation of appropriate data signals is readily facilitated by the use of a personal computer (PC) 33, inclusive of the ‘laptop’ type depicted in FIG. 3, which possesses appropriate software. The computer 33 must further possess a modem 32 functionally connected to a PBX, by radio frequency 20 generated by a radio frequency transmitter 39, as seen in FIG. 3, or transponder as is commonly found in a mobile or cellular telephone and/or a public telephone line 30. Use of the appropriate software is normally considered satisfactory assurance that only transportation personnel 30 will be able to change or control the variable message 12 displayed but the programmable controller 23 may further require an access code for data input if additional security is desired.

FIG. 2 depicts the preferred type of display utilized by a sign 10 in accordance with the principles relating to the present invention, which as mentioned earlier and as illustrated in FIG. 1, is of a moving message type wherein a continuous progression of the characters comprising a given variable message 12 is displayed, preferably from left to right, as indicated in both of these two figures. This is not to deny the use of a left to right progression of characters nor the use of a vertical as opposed to the horizontal disposition shown therein. However this type of display screen 22 is essentially considered most economic in the presentation of a variable message 12 of only one line which is repeated by linear progression, i.e. scrolled, continuously so that a message much longer than would fit upon a single static screen of the same dimensions may be economically provided. A vertical disposition would be sensible in a culture utilizing ideograms each conveying the meaning of a word as in Japanese or Chinese. Yiddish is written from right to left so this progression would be sensible in Israel. In the United States only a left to right progression of characters comprising the variable message 12 displayed is sensible.

Economic considerations similarly dictate that the digital processor 19 be comprised of a programmable controller 23 in providing the binary commands to the array of display elements 21 comprising the display screen 22. The display elements 21 are preferably luminescent but liquid crystal diodes (LCD) is considered feasible with the advantages and disadvantages having been discussed earlier along with the recommended use of light emitting diodes (LED). Incandescent light bulbs may also be utilized as display elements 21 though the heat dissipated by the same and the corresponding power usage are considered excessive in comparison with an LED display screen 22 which, in any case, is comprised of an array of display elements 21 each of which is binary in presentation: on or off, black or light, depending on its status at that time by the digital processor 19 which may be comprised of a computer 33 as discussed below in relation to FIG. 8 if desired. FIGS. 4-8 schematically represent various arrangements of components utilized in a preferred embodiment in accordance with the principles relating to the present invention. FIG. 4 depicts a sign 10 possessing inside: the router 27 to which a single telephonic line 17 is connected; a programmable controller 23; an AC to DC transformer 26 fed by a single electrical supply line 16; and an amplifier 25 also connected to the same electrical supply line 16. A single loudspeaker 15 in this case is depicted exteriorly located with respect to the sign 10 and is connected by a speaker wire 35 to the amplifier inside the sign 10 though this transmission could be wireless if desired though radio transmission for this purpose is considered somewhat extravagant or uneconomic if, cost aside, preferred in avoiding the speaker wire 35 otherwise required. The arrangement of components represented in FIG. 5 differs from that in FIG. 4 in simply having the amplifier 25 exterior to the sign 10 and combined in a single unit with a single loudspeaker 15 which is considered a typical arrangement for a public address (PA) sound system. Use of a readily available or already possessed PA sound system is facilitated. This will, as a matter of practicality, require the use of a second electric supply line 16.

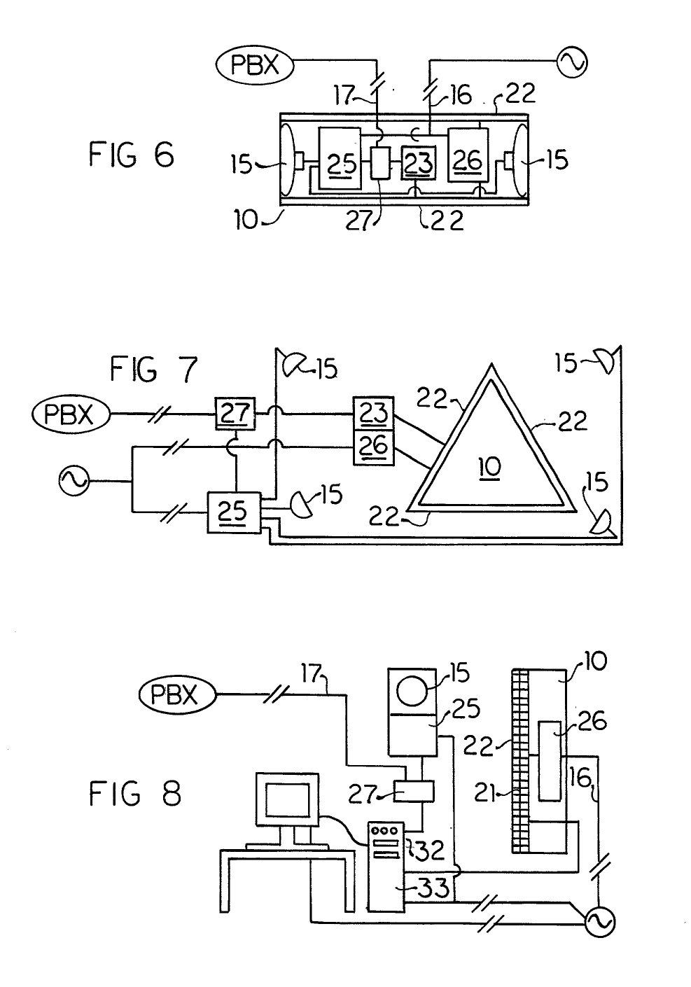

In FIG. 6 a sign 10 possessing two, opposed, display screens 22 is depicted in a manner similar to that suggested previously in discussion of the sign 10 depicted in FIG. 1. This obviously will be more costly than a sign 10 possessing only one display screen 22 but both may be controlled, as represented, by a single programmable controller 23 which is preferably, as shown, interior to the sign 10. The sign 10 depicted in FIG. 6 further possesses two opposed loudspeakers 15, one at either end of the sign 10, which in combination with the two opposed display screens 22, is considered a logically appealing configuration for its symmetry and obvious practicality for disposition in the center of a waiting room 11. In conformance with the arrangement of components represented in FIG. 4, but in contrast to that depicted in FIG. 5, a single electric line 16 is utilized in addition to the utilization of a single telephonic line 17.

FIG. 7 depicts a sign 10 with three display screens 22 in an equilateral triangle as seen from the top or bottom which, for the same reasons discussed in regard to the use of two display screens 22 immediately above, is considered a relatively expensive construction but one which in this case, as opposed to the use of two opposed display screens 22, enables use of the combined length of the display screens 22 for presentation of a single variable message 12 rather than the same single variable message 12 twice. Aside from the use of three display screens 22 the sign 10 depicted in FIG. 7 has none of the other components included within. The programmable controller 23, transformer 26, router 27 and amplifier 25 are all seen to be contained in a unit separate from the sign 10 with an electrical supply line 16 separate from the electrical supply line 16 powering the sign 10. The four loudspeakers 15 are each connected to the amplifier 25 by a separate speaker wire 35 though or an embodiment in accordance with the principles relating to the present invention in which expense is relatively unspared, such as the configuration suggested by FIG. 7, radio transmission of the signal otherwise carried by the speaker wire 35 may be desirable and can be utilized as mentioned earlier.

The arrangement of components depicted in FIG. 8 differs from the configurations depicted in FIGS. 4-7 in replacing the programmable controller 23 with a PC 33 possessing a modem 32. The PC 33 depicted herein, in opposition to the laptop PC 33 depicted in FIG. 3, is of a ‘tower’ configuration which became popular in the mid 1990s and still currently comprises a standard configuration for what is still known as a ‘desktop’ configuration which prior to the mid 1990s had been of a horizontally disposed rectangular box construction. Other configurations of PCs 33 are known, including two recently introduced by Apple™, the first more modest machine combining the monitor with the rather limited hardware required in a somewhat oblate shape, the second more powerful machine utilizing a rather modest sized Cube™ configuration and a separate flat screen monitor i.e. non-cathode ray tube (CRT) type screen. This type of display screen, typically supported in a slight incline off vertical by a single pedestal base, has become most recently utilized in, of course, more expensive PC 33 configurations.

With regard to the principles relating to the present invention the configuration of the PC 33 utilized is of no practical significance; the PC 33 utilized must simply possess sufficient capabilities to substitute for the programmable controller 23 in digital control of the array of display elements 21 comprising the display screen 22 and, in a preferred embodiment, also possess a modem 32 to which a single telephonic line 17 is connected after first passing through the router 27 which is comprised, in a preferred embodiment of the principles relating to the present invention, of a fax-data switch(er). The PC 33, in this case, receives only the data signals from the PBX in accordance with all the above discussion of a preferred embodiment in accordance with the present invention with regard to FIGS. 1-7 and is simply a substitution for the digital control capabilities of the programmable controller 23. The transmission of voice signals received from the PBX is unaffected and the ability to vary the variable message 12 remotely by transportation personnel 19 with appropriate software on a PC 33 is unaffected if the PC 33 utilized in substitution for the programmable controller 23 is simply left on.

It is emphasized that the foregoing is exemplary of a preferred embodiment in accordance with the present invention and is not to be construed in any manner as restrictive of the invention or the rights and privileges secured by Letters Patent for which I claim:

1. A visual message and audio announcement system, primarily intended for location in a waiting room of a public transportation station, said visual message and audio announcement system comprising:
a sign possessing at least one display screen, a digital processor, a signal router, an amplifier, at least one loudspeaker operably connected to said amplifier, and appropriate power supply for: said amplifier, said display screen, said digital processor, and said signal router;
each said display screen being comprised of an array of display elements digitally controlled by said digital processor in the presentation of a variable message thereupon wherein each said display element possesses a binary state determined by said digital processor and patterns within said array form a sufficient number of characters to convey information concerning transportation arrival and departure;
said digital processor further being capable of receiving digital signals generated by appropriate software in both control and alteration of said variable message presented by said display screen;
said signal router being connectable to a telephonic line possessing connection to a PBX and capable of receiving both voice and data signals and routing voice signals to said amplifier and routing data signals to said digital processor;
whereby a voice message received by said single telephonic line is routed to said amplifier resulting in an audio announcement by at least one said loudspeaker and data signals received over said single telephonic line are routed to said digital processor in variation and control of said variable message presented upon at least one said display screen by said array of display elements.

2. The system of claim 1 wherein said sign possesses two display screens.

3. The system of claim 1 wherein said sign possesses three display screens.

4. The system of claim 1 wherein two loudspeakers are utilized.

5. The system of claim 1 wherein four loudspeakers are utilized.

6. The system of claim 1 wherein said audio announcement is effected by a voice signal transmission by a member of the public utilizing a telephone operably connected to a PBX.

7. The system of claim 1 wherein said audio announcement is effected by a voice signal transmission by remote transportation personnel utilizing a telephone operably connected to a PBX.

8. The system of claim 7 wherein said audio announcement is effected by a voice signal transmission by remote, en route, transportation personnel utilizing radio frequency transmission operably connected to a PBX.

9. The system of claim 8 wherein said audio announcement is effected by a voice signal transmission by remote, en route, transportation personnel upon a train utilizing radio frequency transmission operably connected to a PBX.

10. The system of claim 1 wherein said variable message is varied and controlled by data signals generated with appropriate software transmitted by remote transportation personnel utilizing a telephone operably connected to a PBX.

11. The system of claim 10 wherein said variable message is varied and controlled by data signals generated with appropriate software transmitted by remote, en route, transportation personnel utilizing radio frequency transmission operably connected to a PBX.

12. The system of claim 11 wherein said variable message is varied and controlled by data signals generated with appropriate software transmitted by remote, en route, transportation personnel upon a train utilizing radio frequency transmission operably connected to a PBX.

13. The system of claim 1 wherein said digital processor is comprised of a PC.

14. The system of claim 1 wherein said digital processor is comprised of a programmable controller.

15. The system of claim 14 wherein said programmable controller is located within said sign.

16. The system of claim 14 wherein said appropriate power supply includes an AC-DC transformer.

17. The system of claim 16 wherein said AC-DC transformer is located within said sign.

18. The system of claim 14 wherein said signal router is located within said sign.

19. The system of claim 18 wherein at least one said loudspeaker is located upon said sign.

20. The system of claim 19 wherein said amplifier is located within said sign.
